(19) United States
(12) Patent Application Publication
(10) Pub. No.: US 2005/0180582 A1
(43) Pub. Date: Aug. 18, 2005

(54) A System and Method for Utilizing Disjoint Audio Devices

(76) Inventor: Isaac David Guedalia, Beit Shemesh (IL)

Correspondence Address: DANIEL J SWIRSKY, PO BOX 2345, BEIT SHEMESH, 99544, IL

(21) Appl. No.: 10/963,512

(22) Filed: Oct. 14, 2004

Related U.S. Application Data
(60) Provisional application No. 60/544,329, filed on Feb. 17, 2004.
(60) Provisional application No. 60/563,832, filed on Apr. 21, 2004.

(51) Int. Cl. H04R 5/00; H04R 3/00

(52) U.S. Cl. 381/92; 381/122; 379/202.01

(57) ABSTRACT

A communication system is provided including an audio server including an audio server communicator, and a multi-aural filter, and at least one audio device including a microphone set having at least one microphone for audio acquisition of a multi-channel audio signal, and an audio device communicator for communication with the audio server via the audio server communicator, where the multi-aural filter is operative to transform the multi-channel audio signal into an audio signal suitable for communication.

### CROSS-REFERENCE TO RELATED APPLICATIONS

The present application claims priority from U.S. Provisional Patent Application Nos. 60/544,329, filed Feb. 17, 2004, and 60/563,832, filed Apr. 21, 2004, incorporated herein by reference in their entirety.

### FIELD OF THE INVENTION

The present invention relates to audio processing in general, and more particularly to audio processing in a multi-microphone environment.

### BACKGROUND OF THE INVENTION

Audio conferences are an important tool in many corporations today, enabling people in different locations to coordinate their work. A primary goal of an audio conference is to provide a sense of unity and uniformity to the participants. Unfortunately, as is often the case, a poor audio conference may leave certain participants with a feeling of being excluded.

Audio conferences strive for high quality recording and rendering of sound in a full duplex environment, i.e. simultaneously recording and rendering, in order to create the perception that the participants are engaged in a live conference. Unfortunately, sound emitted from a speaker and acoustically echoed within a conference room may be sensed by a microphone in full duplex mode and returned to the originator of the sound.

One approach to solving this problem would be to attach a microphone to each participant. By locating the microphone closer to a desired sound source, i.e. the near-side participant, than to an undesired sound source, i.e. the far-side speaker and its sources of acoustic echo, the sensitivity of the microphone can be easily adjusted to only pick up the near-side participant's voice. Unfortunately, this approach that near-side participants take an active part in positioning the microphones. Moreover, this approach requires a microphone for each participant, further constraining the implementation of the solution.

In yet another methodology, several unidirectional gated microphones are distributed in the conference room. The acoustic characteristics of the microphones ensure that emphasis is placed on the audio sources to which they are directed, enabling near-side participants to direct the microphones towards themselves and away from the far-side speaker and its source of acoustic echo. This methodology similarly suffers from the need to educate near-side participants to direct the microphones towards themselves whenever they speak.

In a different approach, a microphone array may be employed to localize the sound source and attempt to focus on the active speaker, such as by utilizing a beam-forming algorithm. However, localization algorithms in general, and beam-forming technology in particular, are typically computationally intensive and may require sophisticated hardware to perform in real-time.

### SUMMARY OF THE INVENTION

In one aspect of the present invention a communication system is provided including an audio server including an audio server communicator, and a multi-aural filter, and at least one audio device including a microphone set having at least one microphone for audio acquisition of a multi-channel audio signal, and an audio device communicator for communication with the audio server via the audio server communicator, where the multi-aural filter is operative to transform the multi-channel audio signal into an audio signal suitable for communication.

In another aspect of the present invention the pre-amplification of the microphones is configurable by the audio server.

In another aspect of the present invention the audio server is operative to selectably mix the output of any of the audio devices to create an audio channel for transmission to a recipient.

In another aspect of the present invention the audio server is operative to mix the output using an interpolative technique. In another aspect of the present invention the audio server is an IP PBX.

In another aspect of the present invention the communication is a wireless communication.

In another aspect of the present invention the multi-aural filter is operative to perform Griffiths-Jim Beamforming.

In another aspect of the present invention the recipient is a telephone.

In another aspect of the present invention the microphone set the system further includes a chooser and mixer operative to selectably filter output from the microphone.

In another aspect of the present invention the chooser and mixer is operative to determine if the output from one of the microphones is significantly better than the output of the other of the microphones utilizing a predefined measure of significance.

In another aspect of the present invention the chooser and mixer is operative to provide a visual indication of the microphone having the better output.

In another aspect of the present invention the chooser and mixer is operative to mix the output of the microphones where the output from any of the microphones is significantly better than the output of the other of the microphones.

In another aspect of the present invention the microphone set the system further includes a pre-amp operative to amplify the signal provided by the chooser and mixer.

In another aspect of the present invention the microphone set the system further includes an analog to digital converter operative to digitize the amplified signal.

In another aspect of the present invention the audio device communicator is operative to send the digitized output to the audio server.

In another aspect of the present invention the microphone is a unidirectional microphone having an increased sensitivity to audio signals received from a particular direction.

In another aspect of the present invention the microphone set includes a pre-amp operative to amplify a signal provided by each of the microphones, an analog to digital converter operative to digitize each of the amplified signals, and a compressor operative to aggregate the digitized signals and encode the aggregated signals in a multi-channel audio format.

In another aspect of the present invention the audio server is operative to sensitize any of the microphones.

In another aspect of the present invention the audio server is operative to modify at least one encoding parameter of the compressor.

In another aspect of the present invention the audio server is operative to provide a feedback control to the audio device.

In another aspect of the present invention the feedback control is an instruction to the microphone set to illuminate an LED adjacent to the microphone whose audio channel is the clearest among the microphones.

In another aspect of the present invention the feedback control is an instruction to the audio device to set the volume of a speaker associated with the audio device in inverse proportion to a measure of recording clarity of the microphone sets.

In another aspect of the present invention the system further includes a plurality of audio devices, each audio device having one of the microphone sets, and means for inviting users of any of the audio devices to participate in a virtual telephone call.

In another aspect of the present invention the audio server is operative to emit a calibration signal from a speaker, any of the microphones is operative to acquire the calibration signal and transmit the acquired signal to the audio server along a corresponding audio channel, and the audio server is operative to classify the audio channels based on a standard statistical measure.

In another aspect of the present invention the audio server is operative to classify the audio channels whose signal exhibits a relatively high energy level as either of high energy channels and first speaker channels, and audio channels whose signal exhibits a relatively low energy level as either of low energy channels and not first speaker channels.

In another aspect of the present invention the audio server is operative to receive any of the audio channels acquired by the microphone sets and choose any of the audio channels not classified as first speaker channels, and where the microphone set the system further includes a multi-aural filter operative to mix the chosen audio channels and transmit the mixed signal to a recipient.

In another aspect of the present invention the audio server is operative to randomly choose from among the chosen audio channels.

In another aspect of the present invention the audio server is operative to classify the audio channels into classes independent of the calibration.

In another aspect of the present invention the audio server is operative to pre-process any of the audio signals with a frequency transform, and classify the transformed signals utilizing an unsupervised clustering method.

In another aspect of the present invention the audio server is operative to mix eEach of the audio signals in any of the classes to create a single audio channel representative of the class.

In another aspect of the present invention the audio server is operative to choose a single one of the audio channels in any of the classes to best represent the class's audio signal.

In another aspect of the present invention a set of at least two of the microphones are distributed along the circumference of the bounding circle of the microphone set, the audio device includes a speaker and is operative to emit a sound via the speaker, and the audio server is operative to calculate the distance between each of the microphones based on the phase differences between the arrival of the sound at each of the microphones.

In another aspect of the present invention the audio server is operative to determine the most active microphone of each set of microphone sets, calculate the angle between the microphones based on their radial displacement within the microphone set, and calculate the distance from a participant to the most active microphone.

In another aspect of the present invention the audio server is operative to a) determine the most active microphone of each set of microphone sets, b) determine an opposing one of the microphones, c) calculate, respectively, the Discrete Fourier Transforms ‘Fa’ and ‘Fo’ in a sliding window of both the most active and opposing microphones, d) create a mask ‘M’ of ‘Fo’, e) multiply each Fai by ‘Mi’ where Fai=Fai*Mi for all i, where, Mi, represents the mask at index i, and Foi, represents the Discrete Fourier Transform at index I, f) perform steps b)-e) for any other opposing ones of the microphones, g) perform an Inverse Fourier Transform on Fa and add a portion of the original signal, and h) normalize the audio signal of step g) to insure that the maximum values of the audio signal conform to a predefined limit.

In another aspect of the present invention the mask ‘M’ is expressed as Mi=1−(0/(0+exp(−0*CONSTANT*Foi))) where, Mi, represents the mask at an index i, Foi represents the Discrete Fourier Transform at index i, and CONSTANT is a predefined value.

In another aspect of the present invention the audio device the system further includes a divider, and at least one speaker separated from the microphone set by the divider, where the divider is arranged to at least partially inhibit the direct flow of sound produced by the speakers to the microphone set.

In another aspect of the present invention the divider has a textured surface facing the microphone set.

In another aspect of the present invention the textured surface is textured like the pinnea of a human ear.

In another aspect of the present invention the audio device the system further includes a calibrator selectably operative to cause the speaker to emit a calibration sound, where the microphone set is operative to record the calibration sound, and a multi-aural filter operative to calibrate itself using the calibration sound and determine at least one spatial feature of the environment in which the Audio Devices are deployed.

In another aspect of the present invention the audio device the system further includes a clock operative to provide the current time to the audio device, where data transmitted by the audio device includes a time stamp indicating the time at which the audio signal was acquired at the audio device by the microphone set.

In another aspect of the present invention the system further includes a central clock, where any of the audio devices are operative to synchronize its clock with the central clock.

### BRIEF DESCRIPTION OF THE DRAWINGS

The present invention will be understood and appreciated more fully from the following detailed description taken in conjunction with the appended drawings in which:

FIG. 1A is a simplified block diagram of a communication system with disjoint audio devices, constructed and operative in accordance with a preferred embodiment of the present invention;

FIG. 1B is a simplified flowchart illustration of a method of communication between disjoint audio devices, operative in accordance with a preferred embodiment of the present invention;

FIG. 2A is a simplified block diagram of a microphone set, constructed and operative in accordance with a preferred embodiment of the present invention;

FIG. 2B is a simplified flowchart illustration of a method of audio acquisition, operative in accordance with a preferred embodiment of the present invention;

FIG. 3A is a simplified block diagram of an alternative microphone set, constructed and operative in accordance with a preferred embodiment of the present invention;

FIG. 3B is a simplified flowchart illustration of an alternative method of audio acquisition, operative in accordance with a preferred embodiment of the present invention;

FIG. 4A is a simplified block diagram of a set of microphone sets, constructed and operative in accordance with a preferred embodiment of the present invention;

FIG. 4B is a simplified flowchart illustration of a method of calibration of microphones, operative in accordance with a preferred embodiment of the present invention;

FIG. 4C is a simplified flowchart illustration of a method of classification of microphones, operative in accordance with a preferred embodiment of the present invention;

FIG. 5A is a simplified block diagram of a system for participant and speaker localization based on radial information, constructed and operative in accordance with a preferred embodiment of the present invention;

FIG. 5B is a simplified flowchart illustration of a method for speaker localization based on radial information, operative in accordance with a preferred embodiment of the present invention;

FIG. 5C is a simplified flowchart illustration of a method for filtering audio, operative in accordance with a preferred embodiment of the present invention;

FIG. 6, which is a simplified block diagram of an audio device with a divider and calibrator constructed and operative in accordance with a preferred embodiment of the present invention; and

FIG. 7 is a simplified block diagram of microphones with synchronizing clocks, constructed and operative in accordance with a preferred embodiment of the present invention.

### DETAILED DESCRIPTION OF PREFERRED EMBODIMENTS

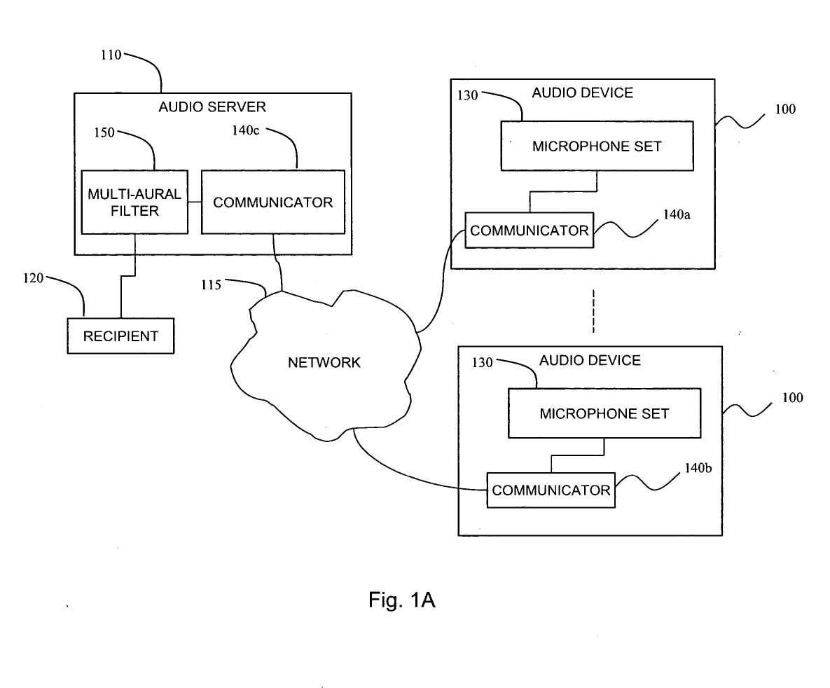

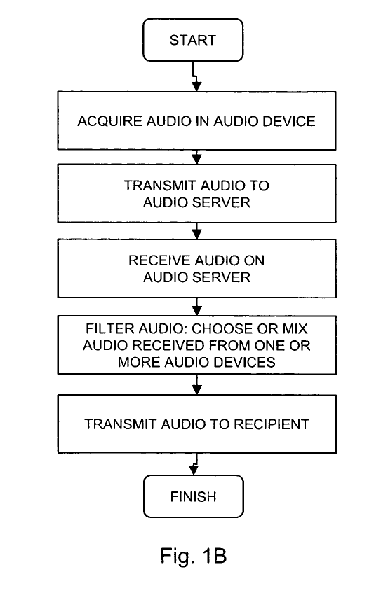

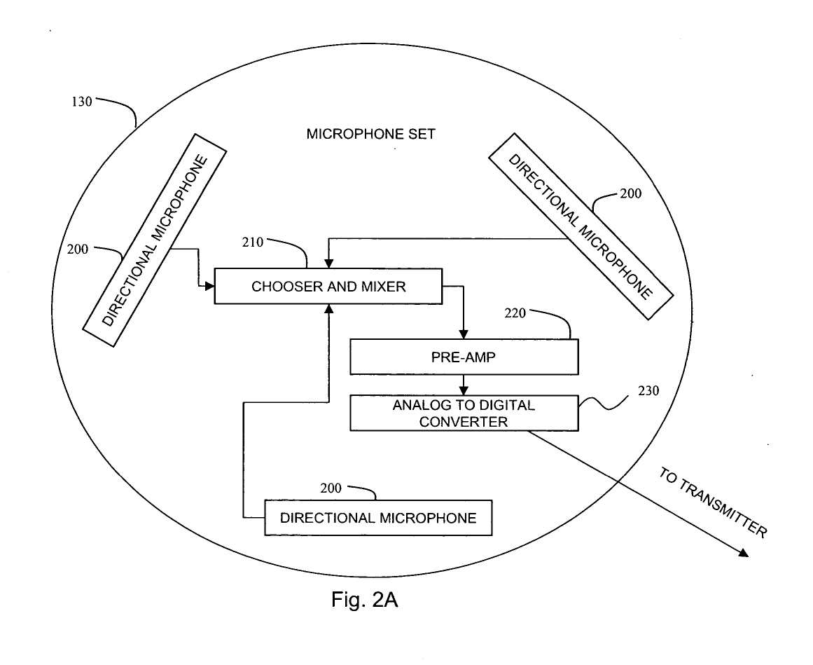

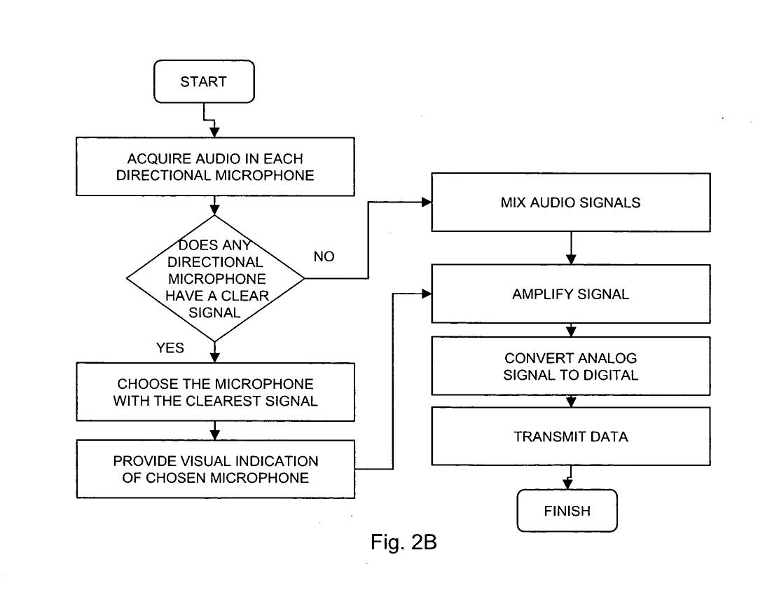

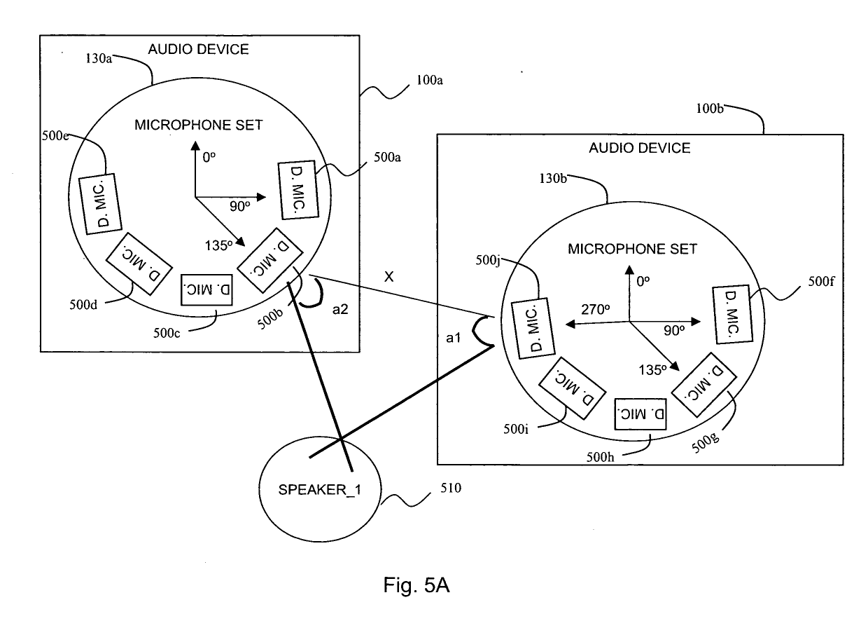

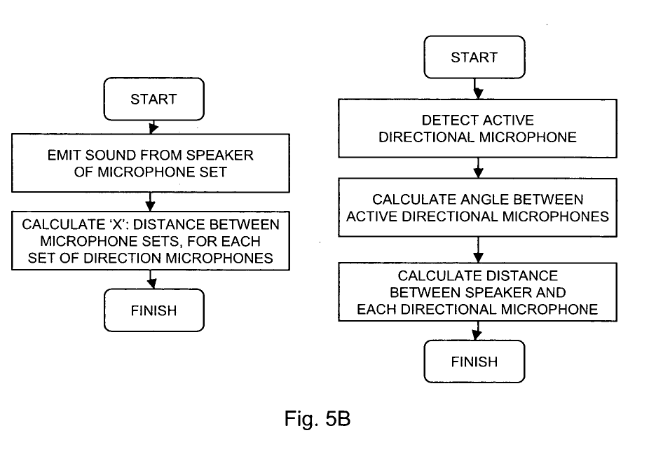

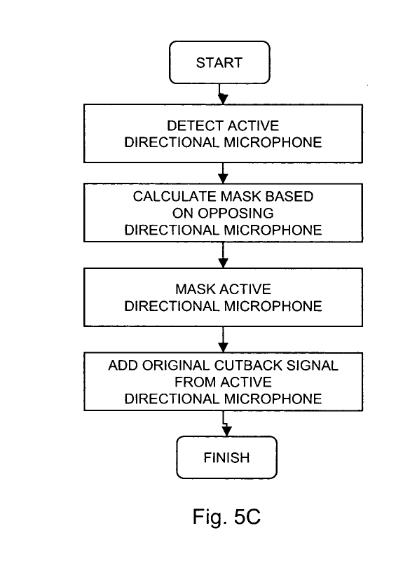

Reference is now made to FIG. 1A, which is a simplified block diagram of a communication system with physically separate audio devices, constructed and operative in accordance with a preferred embodiment of the present invention, and to FIG. 1B, which is a simplified flowchart illustration of a method of communication between physically separate audio devices, operative in accordance with a preferred embodiment of the present invention. In the communication system of FIG. 1A, one or more Audio Devices 100 preferably create a communication channel with an Audio Server 110, such as an IP PBX, over a network 115, such as the Internet. Each Audio Device 100 preferably includes a Microphone Set 130 for audio acquisition of multi-channel audio signals, as described in greater detail hereinbelow with reference to FIGS. 2A through 4C, and a Communicator 140 for communication with Audio Server 110. Audio Server 110 preferably receives the communication, such as a wireless communication, with a Communicator 140b typically situated within Audio Server 110 and transforms the multi-channel audio signal with a Multi-Aural Filter 150, which may implement filtering such as by employing the Griffiths-Jim Beamforming technique, described in L. J. Griffiths and C. W. Jim, “An alternative approach to linearly constrained adaptive beamforming”, IEEE Trans. Antennas Propagation, vol. AP-30, no. 1, pp. 27-34, 1982. Multi-Aural Filter 150 is employed to filter the multi-aural signal into an appropriate audio signal suitable for communication, such as telephone communication, as an alternative to or in conjunction with the filtering technique described with greater detail hereinbelow with reference to FIG. 5C.

Microphone Set 130 is preferably configurable by Audio Server 110 during its operation. For example, the sensitivity of the microphones, e.g. the pre-amplification, within Microphone Set 130 may be adjusted by Audio Server 110.

Communicator 140 preferably communicates using a standard wireless protocol, such as Bluetooth.

Audio Server 100 is capable of coordinating between Audio Devices 100, and may choose or mix their output to create an appropriate audio channel for transmission to a Recipient 120, such as a telephone. Whenever mixing of audio channels occurs, Audio Server 110 preferably employs an interpolative technique to better preserve the radial information, as described in more detail with reference to FIG. 5A and FIG. 5B.

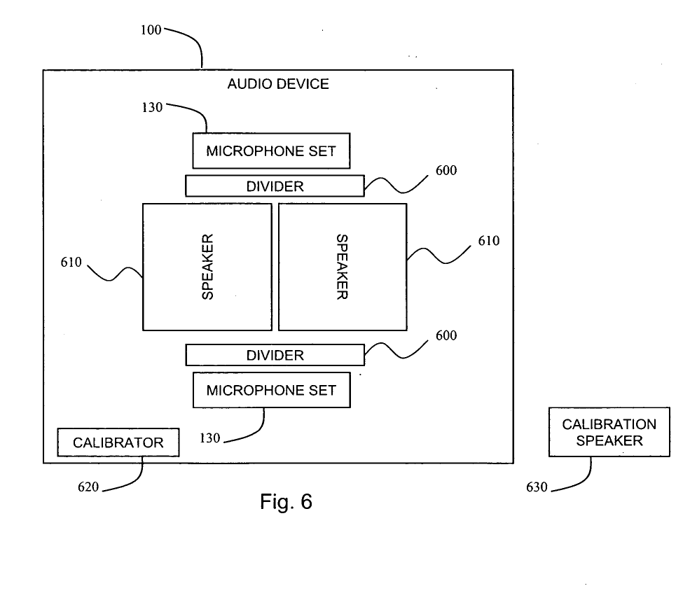

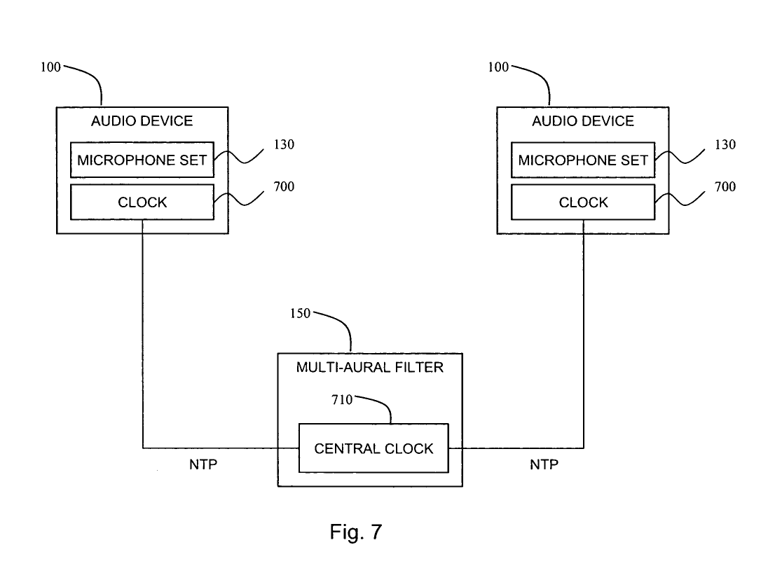

In a typical application, a user of the communication system of FIG. 1A will turn on one or more Audio Devices 100 and initiate a single communication channel between Audio Devices 100 and Audio Server 110. Audio Devices 100 thus collectively form a single virtual telephone, as described in greater detail hereinbelow with reference to FIGS. 6 and 7. Audio Server 110 enables Audio Devices 100 to appear as a single audio device, such as a telephone, to the user and to the recipient of the audio signal, such as a far-end Recipient 120.

Reference is now made to FIG. 2A, which is a simplified block diagram of an implementation of Microphone Set 130 of FIG. 1A, constructed and operative in accordance with a preferred embodiment of the present invention, and to FIG. 2B, which is a simplified flowchart illustration of a method of audio acquisition, operative in accordance with a preferred embodiment of the present invention. Microphone Set 130 preferably includes one or more Microphones 200, which may be a unidirectional microphone with an increased sensitivity to audio signals received from a particular direction, such as HMU06C, commercially available from JL WORLD, 309 Kodak House II, 39 Healthy Street, East North Point, Hong Kong. Microphone Set 130 also preferably includes a Chooser and Mixer 210, a Pre-Amp 220, and an Analog to Digital Converter 230. Each Microphone 200 provides a separate audio channel, the output of which is preferably filtered by Chooser and Mixer 210. Chooser and Mixer 210 preferably first determines if the output from one of the Microphones 200 is significantly better than the other Microphones 200, utilizing any known measure of significance, e.g. energy.

Should the output of one of the Microphones 200 indeed be significantly better, Chooser and Mixer 210 preferably chooses its output for further processing. In addition, Chooser and Mixer 210 may provide a visual indication of the chosen Microphone 200, such as by illuminating an LED located adjacent to the microphone (not shown). Otherwise, Chooser and Mixer 210 mixes the output of the Microphones 200, as is well known in the art, and sends them on for further processing.

The result of Chooser and Mixer 210 is preferably further processed by Pre-Amp 220 which amplifies the signal prior to digitization by Analog to Digital Converter 230. The digital output is then sent to Communicator 140 for transmission to Audio Server 110.

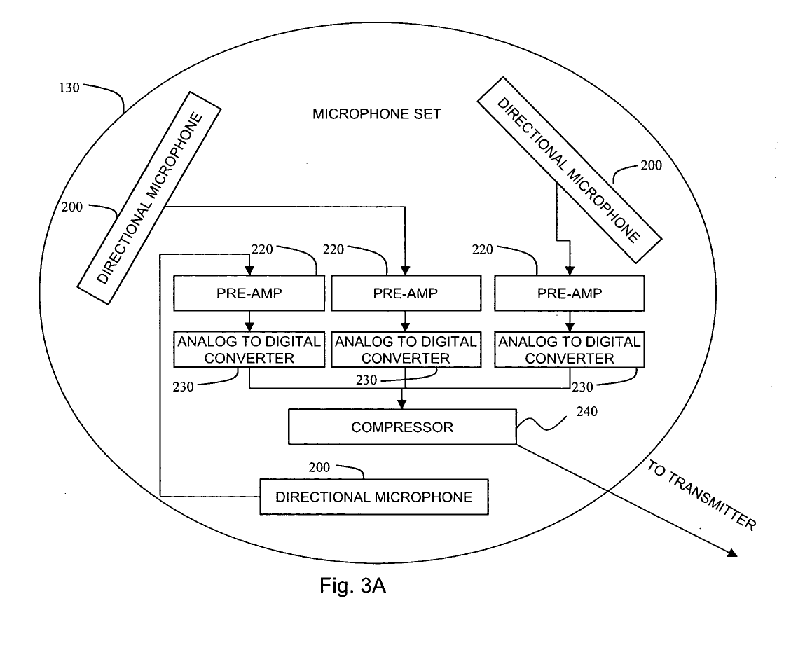

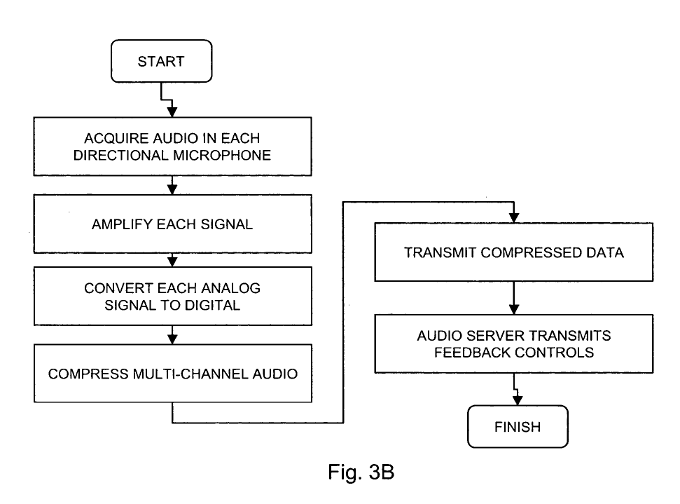

Reference is now made to FIG. 3A, which is a simplified block diagram of an alternative implementation of Microphone Set 130 of FIG. 1A, constructed and operative in accordance with a preferred embodiment of the present invention, and to FIG. 3B, which is a simplified flowchart illustration of an alternative method of audio acquisition, operative in accordance with a preferred embodiment of the present invention. In FIG. 3A, Microphone Set 130 is implemented in a manner that is similar to the implementation shown in FIG. 2A, with the notable exception that Microphone Set 130 preferably includes a Compressor 240 and does not include Chooser and Mixer 210, the functionality of which is provided by audio server 210. Each audio channel acquired by Microphone 200 is processed independently within Microphone Set 130, aggregated, and then transmitted to Audio Server 110. Each Microphone 200 sends its audio output to Pre-Amp 220, then to Analog to Digital Converter 230, and lastly to a Compressor 240. Compressor 240 preferably aggregates the multi-channel digital audio, and may encode the audio in a multi-channel audio format, such as the Ogg Vorbis format. Pre-Amp 220, Analog to Digital Converter 230 and Compressor 240 are preferably configurable from Audio Server 110, such that Audio Server 110 may be capable of sensitizing a particular Microphone 200 or modifying the encoding parameters of Compressor 240.

In addition, Audio Server 110 preferably provides feedback controls, such as visual or audio feedback, to Audio Device 100. For example, Audio Server 110 may instruct Microphone Set 130 to illuminate an LED adjacent to the Microphone 200 whose audio channel is the clearest, where clarity is defined by any known measure of clarity as is well known in the art, such as the measure provided by a Voice Activity Detector. In this manner the participants may receive visual feedback indicating which microphone is receptive to their voice. In another example, the recording clarity of Microphone Set 130, which may be defined as sum total clarity of each audio channel as described above, may be utilized to attenuate a speaker. Thus, Audio Server 110 may instruct an Audio Device 100 that includes a speaker, such as Audio Device 100 described hereinbelow with reference to FIG. 6, to set the volume of the speaker in inverse proportion to the recording clarity, e.g. the lower the recording clarity the louder the speaker. In this manner the participant may receive audio feedback.

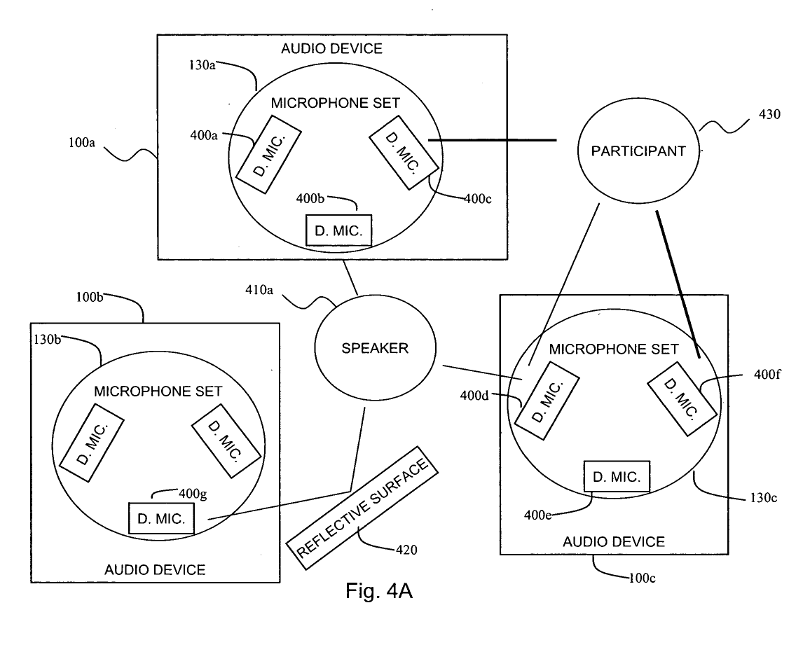

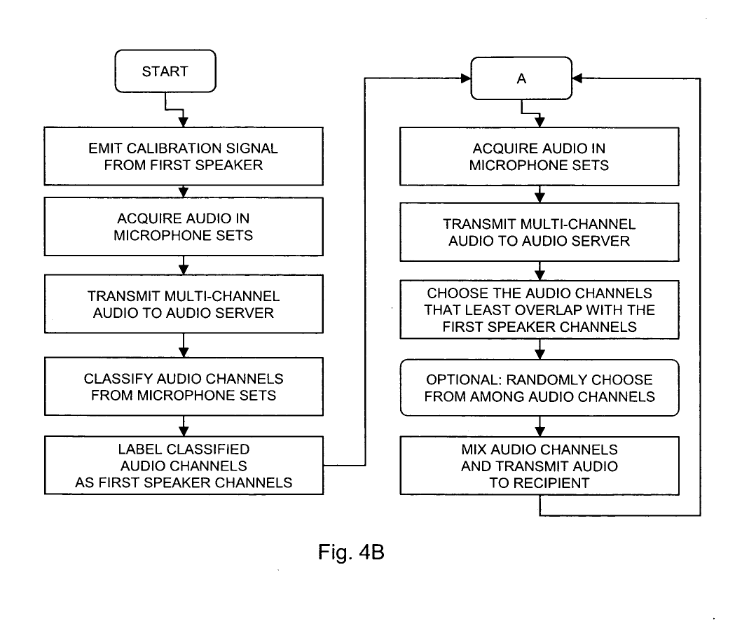

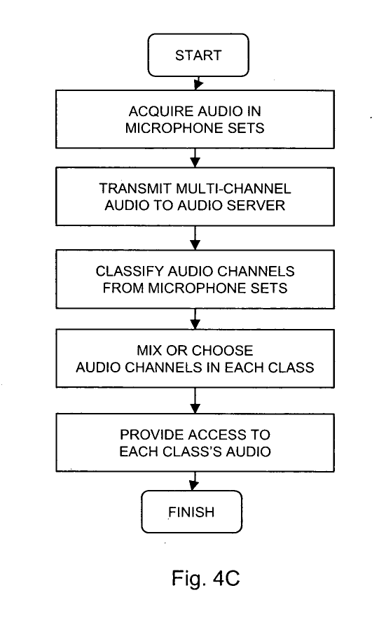

Reference is now made to FIG. 4A, which is a simplified block diagram of a physically separate group of Audio Devices 100, constructed and operative in accordance with a preferred embodiment of the present invention, FIG. 4B, which is a simplified flowchart illustration of a method of calibration of Microphones, operative in accordance with a preferred embodiment of the present invention, and FIG. 4C, which is a simplified flowchart illustration of a method of classification of Microphones, operative in accordance with a preferred embodiment of the present invention. In FIG. 4A, a group of physically separate Audio Devices 100 (FIG. 1A), each having a Microphone Set 130, are actively invited, typically when a participant of a conference call pushes an ‘on’ button (not shown), to participate in a virtual telephone call as follows. Audio Server 110 preferably emits a calibration signal, such as a DTMF sound, from a first Speaker 410a. The signal is acquired by one or more Microphones labeled 400a through 400g, located within Microphone Sets 130. The audio signal acquired by each Microphone Set 130, as described hereinabove with reference to FIGS. 2A, 2B, 3A and 3B, is transmitted to Audio Server 110. Each audio channel is then classified by Audio Server 110 employing any known classification technique, such as an unsupervised clustering of the audio channels, based on a standard statistical measure, such as the Euclidian distance between audio signals. The calibration signal may further be utilized by Audio Server 110 to calibrate other features of the system, such as the relative location of each audio device, e.g. are they in the same room, as described in more detail hereinbelow with reference to FIG. 6B.

For example, if Speaker 410a, as shown in FIG. 4A, is significantly closer to Microphones 400b and 400d than to other Microphones, the audio signal received on their respective audio channels will typically exhibit a higher energy level than that which is received from other Microphones 400. Microphones with high energy levels, i.e. above a predefined threshold, may be classified in a separate group than those that have a low energy level, employing any well known classification technique, such as a statistical classifier, e.g. cluster analysis. Audio Server 110 preferably labels the high energy channels as ‘first speaker channels’ and the low energy channels as ‘not first speaker channels’.

After the calibration of the physically separate group of Audio Devices 100, the sounds emitted by a user of the present invention, such as a user shown in FIG. 4A as participant 430, may be filtered as follows. Audio Server 110 receives the audio channels acquired by Microphone Sets 130 and preferably chooses the audio channel not classified as ‘first speaker channels’. Multi-Aural Filter 150, in Audio Server 110, preferably mixes the chosen audio channels and may then transmit them to Recipient 120.

In an optional step, Audio Server 110 may randomly choose from among the audio channels. This option may help break feedback loops typically caused by audio signals emitted by a speaker, sensed by a microphone, and then reproduced by the speaker, sensed by the microphone again, etc.

In an alternative classification method, shown in FIG. 4C, audio channels acquired from Microphones 400 are preferably classified into classes independent of the calibration step. For example, the audio signals may be pre-processed with a frequency transform, such as the discrete cosine transform, and automatically classified utilizing an unsupervised clustering method, such as the ‘Kmeans’ method described by MacQueen, J. in “Some methods for classification and analysis of multi-variant observations”. Proc. 5th Berkeley Symp. Mathematical Statist. and Probability, pages 281-297 (1967). Each of the audio signals in each class are preferably mixed together to create a single audio channel representative of each class. Alternatively, a single audio channel may be chosen from a class to best represent its audio signal. The representative audio channels may then be made available to Multi-Aural Filter 150 for processing, as described hereinabove with reference to FIGS. 1A-1B.

For example, in a room with multiple audio sources, e.g. speakers and participants, it is expected that one or more Microphones 400 will be more sensitive to a particular audio source than other Microphones 400, i.e. not all Microphones 400 will record the same audio. As opposed to choosing a loudest audio source or mixing the input from the different audio sources, the method of FIG. 4C enables an application to preserve each audio source's audio independently. A moderator may choose to enable a specific audio source, i.e. filter out audio from other audio sources, and thus minimize the confusion heard on the far-side.

Reference is now made to FIG. 5A, which is a simplified block diagram of a system for speaker localization based on radial information, constructed and operative in accordance with a preferred embodiment of the present invention, and to FIG. 5B, which is a simplified flowchart illustration of a method for sound source localization based on radial information, operative in accordance with a preferred embodiment of the present invention. In the system of FIG. 5A a set of at least two microphones 500 are distributed along the circumference of the bounding circle of microphone set 130, which is located in Audio Device 100, shown in FIG. 1. In the method of FIG. 5B, sounds emitted from a sound source, such as a speaker or a participant, which are typically detected at one or more Microphone Sets 130, will arrive at each microphone 500 with a displacement which is a function of the distance from the speaker to the microphone. As is well known in the art, methodologies which attempt to synchronize the audio signals that arrive at the microphones, such as beamforming, typically determine the phase differences between microphones. For example, given a planar microphone array, a cross-correlation between the audio outputs of the microphones typically yields a peak offset for each set of microphones, which correlates to the phase difference between the microphones due to their spatial displacement.

In the method of FIG. 5B, radial information latent in Microphone Set 130 is employed to localize a sound source and may be utilized to calculate the distance between a Microphone 500 and the sound source. For example, in an initialization stage, a sound is emitted from a speaker located within Audio Device 100, as described in more detail hereinbelow with reference to FIGS. 6 and 7. Audio Server 110 preferably calculates the distance between each Microphone 500 based on the phase differences between their respective audio signals, as is well known in the art. During runtime, a participant's distance to a Microphone 500 may be calculated, as shown in FIG. 5B, as follows:
1. Determine the most active Microphone 500 in each set of Microphone Sets 130.
2. Calculate the angle between Microphones 500 based on their radial displacement within Microphone Set 130.
3. Calculate the distance from the participant to the Microphone 500

Reference is now made to FIG. 5C, which is a simplified flowchart illustration of a method for filtering audio, operative in accordance with a preferred embodiment of the present invention. In the method of FIG. 5C, after the most active Microphone 500 is determined, as described hereinabove with reference to FIG. 5B, the audio signal transmitted by the most active Microphone 500 is preferably filtered based on information obtained by one or more opposing Microphones 500 as follows:
1. Determine an opposing Microphone 500. For example, if the most active Microphone 500 is determined to be Microphone 500e (shown in FIG. 5A), an opposing Microphone 500 is preferably chosen as one that faces away from the active Microphone 500e, e.g., Microphone 500a, such as by 160 to 200 degrees.
2. Calculate, respectively, the Discrete Fourier Transforms ‘Fₐ’ and ‘Fₒ’ in a sliding window, as is well known in the art, of both the most active and the opposing Microphones.
3. Create a mask ‘M’ of ‘Fₒ’, for example:
   Mᵢ=1−(1.0/(1.0+exp (−1.0*CONSTANT*Fₒᵢ)))
Where, Mᵢ, represents the mask at index i, and Fₒᵢ, represents the Discrete Fourier Transform at index i, and CONSTANT is a predefined value such as ‘20’ which may be set using any known heuristic technique.
4. Multiply each Fₐᵢ by ‘Mᵢ’; Fₐᵢ=Fₐᵢ*Mᵢ for all i.
5. Performs steps 1-4 for other opposing Microphones 500.
6. Perform the Inverse Fourier Transform on Fₐ and add a portion of the original signal, e.g., the original signal attenuated by 10%; Iₐ=InverseFft(Fₐ); Rᵢ=Iₐᵢ+(Sᵢ*0.1) for all i, where Rᵢ is the resultant signal at index i, Iₐᵢ is the result of the inverse Fourier Transform at index i, and Sᵢ is the original signal at index i.
7. Normalize the audio signal, i.e. insure that the maximum values of the audio signal conform to required limits, such as 0 through 255 in an 8 bit representation.

Reference is now made to FIG. 6, which is a simplified block diagram of Audio Device 100 of FIG. 1A, with a Divider 600, constructed and operative in accordance with a preferred embodiment of the present invention. To enhance the disparity between the sounds reaching different microphones, such as Microphone Sets 130, a set of Speakers 610 are separated from the Microphone Sets 130 by a Divider 600. Divider 600 inhibits the direct flow of the sound produced by Speakers 610 to Microphone Set 130. Divider 600 is typically constructed to protect and amplify sound much like a micro-amphitheatre. Furthermore, Divider 600 may also have a textured inner surface, i.e. the surface facing the Microphone Set 130 may be textured like the pinnea of a human ear. The texture is designed to increase the disparity of sound received from different spatial locations.

A Calibrator 620, such as a button typically labeled ‘calibration’, is preferably located on Audio Device 100. When Calibrator 620 is employed by a user, a sound is preferably emitted by one or more of Speakers 610 and is recorded by Microphone Set 130. The calibration sound may be utilized by Multi-Aural Filter 150 to calibrate itself using calibration techniques, such as those described with respect to Griffiths-Jim Beamforming. Multi-Aural Filter 150 may then determine the spatial features of the environment in which Audio Devices 100 are deployed. For example, the calibration sound may be emitted when the audio device is powered on.

Reference is now made to FIG. 7, which is a simplified block diagram of microphones with synchronizing clocks, constructed and operative in accordance with a preferred embodiment of the present invention. Each Audio Device 100, shown in FIG. 1A, preferably includes a clock, such as clock 700 in FIG. 7, that enables the retrieval of the current time by Audio Device 100. The audio data transmitted by Audio Device 100 preferably includes a time-stamp, i.e. the time at which the audio was acquired at Audio Device 100 by Microphone Set 130. A central clock 710, which typically resides within Multi-Aural Filter 150 shown in FIG. 1A, is employed by Multi-Aural Filter 150 as a point of reference by which all other clock's 700 are measured against. Each Audio Device 100 synchronizes its clock 700 with central clock 710, preferably using a network protocol such as NTP.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

1. A communication system comprising:
an audio server comprising:
an audio server communicator; and
a multi-aural filter; and
at least one audio device comprising:
a microphone set having at least one microphone for audio acquisition of a multi-channel audio signal; and
an audio device communicator for communication with said audio server via said audio server communicator,
wherein said multi-aural filter is operative to transform said multi-channel audio signal into an audio signal suitable for communication.

3. A communication system according to claim 1 wherein the pre-amplification of said microphones is configurable by said audio server.

4. A communication system according to claim 1 wherein said audio server is operative to selectably mix the output of any of said audio devices to create an audio channel for transmission to a recipient.

5. A communication system according to claim 4 wherein said audio server is operative to mix said output using an interpolative technique.

6. A communication system according to claim 1 wherein said audio server is an IP PBX.

7. A communication system according to claim 1 wherein said communication is a wireless communication.

8. A communication system according to claim 1 wherein said multi-aural filter is operative to perform Griffiths-Jim Beamforming.

9. A communication system according to claim 4 wherein said recipient is a telephone.

11. A communication system according to claim 1 wherein said microphone set further comprises a chooser and mixer operative to selectably filter output from said microphone.

12. A communication system according to claim 11 wherein said chooser and mixer is operative to determine if the output from one of said microphones is significantly better than the output of the other of said microphones utilizing a predefined measure of significance.

13. A communication system according to claim 12 wherein said chooser and mixer is operative to provide a visual indication of said microphone having said better output.

14. A communication system according to claim 11 wherein said chooser and mixer is operative to mix the output of said microphones where the output from any of said microphones is significantly better than the output of the other of said microphones.

15. A communication system according to claim 11 wherein said microphone set further comprises a pre-amp operative to amplify the signal provided by said chooser and mixer.

16. A communication system according to claim 15 wherein said microphone set further comprises an analog to digital converter operative to digitize said amplified signal.

17. A communication system according to claim 16 wherein said audio device communicator is operative to send said digitized output to said audio server.

18. A communication system according to claim 1 wherein said microphone is a unidirectional microphone having an increased sensitivity to audio signals received from a particular direction.

19. A communication system according to claim 11 wherein said microphone set comprises:
a pre-amp operative to amplify a signal provided by each of said microphones;
an analog to digital converter operative to digitize each of said amplified signals; and
a compressor operative to aggregate said digitized signals and encode said aggregated signals in a multi-channel audio format.

20. A communication system according to claim 19 wherein said audio server is operative to sensitize any of said microphones.

21. A communication system according to claim 19 wherein said audio server is operative to modify at least one encoding parameter of said compressor.

22. A communication system according to claim 19 wherein said audio server is operative to provide a feedback control to said audio device.

23. A communication system according to claim 19 wherein said feedback control is an instruction to said microphone set to illuminate an LED adjacent to the microphone whose audio channel is the clearest among said microphones.

24. A communication system according to claim 19 wherein said feedback control is an instruction to said audio device to set the volume of a speaker associated with said audio device in inverse proportion to a measure of recording clarity of said microphone sets.

25. A communication system according to claim 1 and further comprising:
a plurality of audio devices, each audio device having one of said microphone sets; and
means for inviting users of any of said audio devices to participate in a virtual telephone call.

26. A communication system according to claim 25 wherein:
said audio server is operative to emit a calibration signal from a speaker,
any of said microphones is operative to acquire said calibration signal and transmit said acquired signal to said audio server along a corresponding audio channel, and
said audio server is operative to classify said audio channels based on a standard statistical measure.

27. A communication system according to claim 26 wherein said audio server is operative to classify said audio channels whose signal exhibits a relatively high energy level as either of high energy channels and first speaker channels, and audio channels whose signal exhibits a relatively low energy level as either of low energy channels and not first speaker channels.

28. A communication system according to claim 27 wherein said audio server is operative to receive any of said audio channels acquired by said microphone sets and choose any of said audio channels not classified as first speaker channels, and wherein said microphone set further comprises a multi-aural filter operative to mix said chosen audio channels and transmit said mixed signal to a recipient.

29. A communication system according to claim 28 wherein said audio server is operative to randomly choose from among said chosen audio channels.

30. A communication system according to claim 26 wherein said audio server is operative to classify said audio channels into classes independent of said calibration.

31. A communication system according to claim 30 wherein said audio server is operative to pre-process any of said audio signals with a frequency transform, and classify said transformed signals utilizing an unsupervised clustering method.

32. A communication system according to claim 30 wherein said audio server is operative to mix each of said audio signals in any of said classes to create a single audio channel representative of said class.

33. A communication system according to claim 30 wherein said audio server is operative to choose a single one of said audio channels in any of said classes to best represent said class's audio signal.

34. A communication system according to claim 1 wherein
a set of at least two of said microphones are distributed along the circumference of the bounding circle of said microphone set,
said audio device includes a speaker and is operative to emit a sound via said speaker, and
said audio server is operative to calculate the distance between each of said microphones based on the phase differences between the arrival of said sound at each of said microphones.

35. A communication system according to claim 1 wherein said audio server is operative to
determine the most active microphone of each set of microphone sets,
calculate the angle between said microphones based on their radial displacement within said microphone set, and
calculate the distance from a participant to said most active microphone.

36. A communication system according to claim 1 wherein said audio server is operative to
a) determine the most active microphone of each set of microphone sets,
b) determine an opposing one of said microphones;
c) calculate, respectively, the Discrete Fourier Transforms ‘Fₐ’ and ‘Fₒ’ in a sliding window of both said most active and opposing microphones;
d) create a mask ‘M’ of ‘Fₒ’;
e) multiply each Fₐᵢ by ‘Mᵢ’ where Fₐᵢ=Fₐᵢ*Mᵢ for all i, where, Mᵢ, represents the mask at index i, and Fₒᵢ, represents the Discrete Fourier Transform at index I;
f) perform steps b)-e) for any other opposing ones of said microphones;
g) perform an Inverse Fourier Transform on Fₐ and add a portion of the original signal; and
h) normalize the audio signal of step g) to insure that the maximum values of the audio signal conform to a predefined limit.

37. A communication system according to claim 36 wherein said mask ‘M’ is expressed as:
Mᵢ=1−(1.0/(1.0+exp (−1.0*CONSTANT*Fₒᵢ)))
where, Mᵢ, represents said mask at an index i, Fₒᵢ represents the Discrete Fourier Transform at index i, and CONSTANT is a predefined value.

38. A communication system according to claim 1 wherein said audio device further comprises:
a divider; and
at least one speaker separated from said microphone set by said divider, wherein said divider is arranged to at least partially inhibit the direct flow of sound produced by said speakers to said microphone set.

39. A communication system according to claim 38 wherein said divider has a textured surface facing said microphone set.

40. A communication system according to claim 39 wherein said textured surface is textured like the pinnea of a human ear.

41. A communication system according to claim 38 wherein said audio device further comprises:
a calibrator selectably operative to cause said speaker to emit a calibration sound, wherein said microphone set is operative to record said calibration sound; and
a multi-aural filter operative to calibrate itself using said calibration sound and determine at least one spatial feature of the environment in which said Audio Devices are deployed.

42. A communication system according to claim 1 wherein said audio device further comprises a clock operative to provide the current time to said audio device, wherein data transmitted by said audio device includes a time stamp indicating the time at which said audio signal was acquired at said audio device by said microphone set.

43. A communication system according to claim 42 and further comprising a central clock, wherein any of said audio devices are operative to synchronize its clock with said central clock.
